(19) United States
(12) Patent Application Publication
(10) Pub. No.: US 2012/0246059 A1
(43) Pub. Date: Sep. 27, 2012

(54) METHOD AND SYSTEM FOR REPRESENTING FINANCIAL MARKET TRANSACTIONS

(76) Inventor: Darryl John Mahoney, Alexandra Headland (AU)

(21) Appl. No.: 13/513,187

(22) PCT Filed: Dec. 3, 2010
(86) PCT No.: PCT/AU10/01629

§ 371 Date: May 31, 2012

(30) Foreign Application Priority Data
Dec. 4, 2009 (AU) 2009905938

(51) Int. Cl. G06Q 40/04

(52) U.S. Cl. 705/37

(57) ABSTRACT

A computer implement method of representing financial market transactions includes the steps of: recording a time an order was created in a course of sales; determining whether the order was for buying or selling of a fungible item; generating a buyer data stream representative of buying transactions according to the buying of such fungible items; generating a seller data stream representative of selling transactions according to the selling of fungible items, and representing the buyer data stream and the seller data stream on a chart, wherein the financial market transactions are simultaneously represented according to a volume of both buyer and seller transactions.

### BACKGROUND OF THE INVENTION

This invention relates to a method and associated system for representing financial market transactions.

### DESCRIPTION OF THE PRIOR ART

Reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

FIG. 1 shows a conventional manner of graphically representing financial market transactions and information, such as stock market activity. Reference numeral 10 indicates a value BVol, which is the total amount of shares available on offer by people who want to buy stock but do not want to pay the price of the offer that sellers are offering. This volume also includes all participants prepared to execute at that price. Reference numeral 12 indicates a Bid value, which is the price that the potential buyers are prepared to pay for the stock by letting sellers hit their offer. Reference numeral 14 indicates an Ask value, which is the price sellers are currently willing to accept by allowing buyers to hit their offer.

Reference numeral 16 indicates a value AVol, which is the total amount of shares available by all market participants that are prepared to sell. Reference numeral 18 indicates Price, which is the price the last transaction occurred at during the Course of Sales, generally presented as the ticker tape of the market. Reference numeral 20 indicates Vol, is the volume of transactions which occurred at the relevant Price value 18. Reference numeral 22 indicates Time, which is the exact time and date the relevant transaction occurred.

For example, reference numeral 24 indicates the volume of transactions which occurred during the course of sales at the time of 16:29.57. This volume 24 was transacted in one transaction, wherein it was bought by one person at the price of 4728. The current information is displayed as all the individual sellers who were prepared to sell to the buyer at a price of 4728. This combination is commonly referred to as market depth.

To represent the transactions, the transaction that occurred at the particular price is plotted on a chart at a position indicated by reference numeral 26 using increments of time, such as 2 minute intervals indicated by reference numeral 28, to record all transactions that occurred in that nominated amount of time. Reference numeral 30 indicates a plot of the volume of transactions which is transacted in the period indicated at 28.

The conventional methods only allow representation of transactions by the number of people transacting over the generally inefficient increment of time used to record the transactions and display them on a chart. Time is inefficient as it does not account for the volume of transactions 30. As the market trades at various speeds throughout the day, variations in trading volume by up to a factor of six can occur when comparing equal increments of time as a form of measurement. The prior art methods do not provide for an efficient means whereby a volume of sales can be represented as an accurate indication of financial market conditions.

### SUMMARY OF THE PRESENT INVENTION

According to a first aspect of the invention there is provided a method of representing financial market transactions, said method including the steps of:
recording a time an order was created in a course of sales;
determining whether the order was for buying or selling of a fungible item;
generating a buyer data stream representative of buying transactions according to the buying of such fungible items;
generating a seller data stream representative of selling transactions according to the selling of fungible items; and
representing the buyer data stream and the seller data stream on a chart, wherein the financial market transactions are simultaneously represented according to a volume of both buyer and seller transactions.

Typically, the step of determining whether the order was for buying or selling of fungible items includes determining whether the order was recorded as a buyer bid or as a seller bid at the time of the order.

Typically, the method includes determining a current achievement level of buyer transactions and seller transactions via comparison of the volume of buyer and seller transactions.

Typically, the method is performed in real-time as the transactions are concluded.

According to a second aspect of the invention, there is provided a system for representing financial market transactions, said system including:
a processor for executing instructions;
memory arranged in signal communication with the processor via a communications bus, said memory for storing the instructions;
non-volatile storage arranged in signal communication with the memory and processor via the bus, the storage configured for storing the instructions; and
an interface arranged in signal communication with the processor, memory and storage, the interface for receiving instructions from a user and for displaying results of the executed instructions to the user, wherein the processor is configured to execute a set of instructions in order to perform a method according to the first aspect of the invention.

A further aspect of the invention provides for a computer-readable medium which includes a set of instructions which, when executed by a processor, causes a computer to perform the method steps according to the first aspect of the invention.

A yet further aspect of the invention provides for a general-purpose digital computer programmed to carry out steps according to the method of the first aspect of the invention.

### BRIEF DESCRIPTION OF THE DRAWINGS

An example of the present invention will now be described with reference to the accompanying drawings, in which: —

FIG. 1 shows a screen capture of a conventional manner of displaying financial market transactions;

FIG. 2 shows one example of a screen capture of a chart produced by a method of representing financial market transactions according to the current arrangement;

FIG. 3 shows an example of a manner in which the method of representing financial market transactions interprets the information of FIG. 1;

FIG. 4 shows a diagrammatic representation of an example of a system for representing financial market transactions according to the current arrangement;

FIG. 5 shows an example of an additional indicator for showing a speed at which transactions occur;

FIG. 6 shows an example of a further indicator showing the actual buying and selling transactions and a volume of the respective transactions;

FIG. 7 shows a yet further indicator providing additional information of the transactions;

FIG. 8 shows an additional indicator indicating squaring of market achievement;

FIG. 9 shows an additional indicator indicating a volume of transactions at each price point in a range of transactions; and

FIG. 10 shows a screen capture of an analysis conducted on the chart of FIG. 2.

### DETAILED DESCRIPTION OF PREFERRED EXAMPLES

The current arrangement provides for a method of representing financial market transactions, as described in more detail below. The method generally includes the steps of recording a time an order was created in a course of sales, determining whether the order was for buying or selling of fungible items, such as stock, generating a buyer data stream representative of buying transactions according to the buying of fungible items, and generating a seller data stream representative of selling transactions according to the selling of such fungible items. The method of the current arrangement also includes representing the buyer data stream and the seller data stream on a chart, wherein the financial market transactions are simultaneously represented according to a volume of both buyer and seller transactions.

It is to be appreciated that the following examples typically refer to the trading of stock. However, the examples are also applicable to other fungible items, including financial securities (such as stocks and bonds), commodities (such as precious metals or agricultural goods), and/or any other suitable fungible items. In one example, the step of determining whether the order was for buying or selling of stock includes determining whether the order was recorded as a buyer bid or as a seller bid at the time of the order. In a further example, the method includes determining a current achievement level of buyer transactions and seller transactions via comparison of the volume of buyer and seller transactions. Generally, the method is performed in real-time as the transactions are concluded.

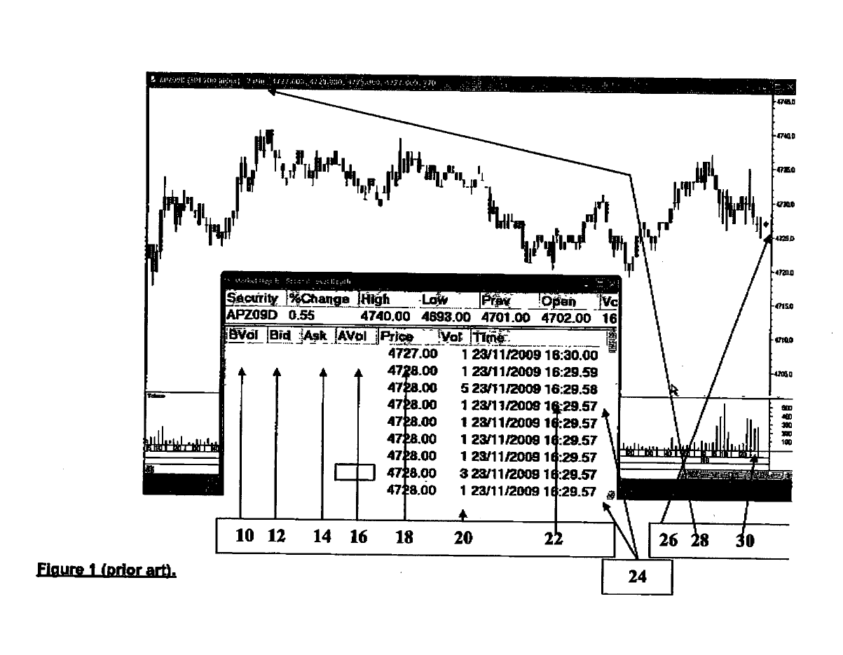

With reference now firstly to FIG. 3 of the drawings, there is shown a screen capture of transactions during a course of sale as shown in FIG. 1 and described above. All the transaction information is displayed as transactions that have occurred. The method according to the current arrangement allows determination of the volume of transactions, represented by reference numeral 32, which was bought by a single buyer. The volume transacted and indicated by reference numeral 34 was traded at a similar price as the transaction at 32, but in this instance was sold by 2 sellers, one seller sold 5 and another seller sold 1. The transaction at reference numeral 36 was a sale of a single share.

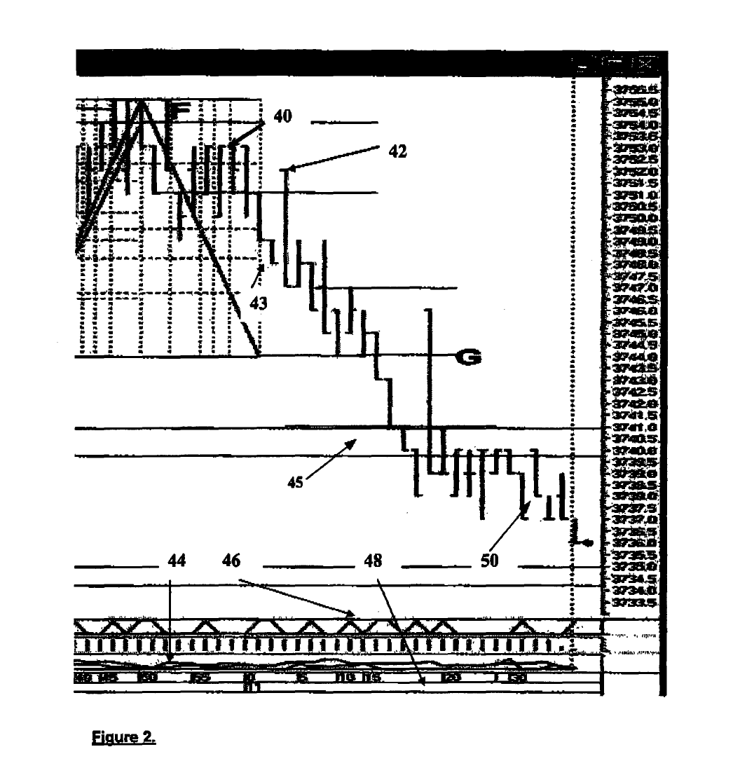

Referring now to FIG. 2 of the drawings, the method of the current arrangement allows for the representation of both buyer and seller transactions. In FIG. 2, it is to be appreciated that the dark black bars represent buyer transactions, with the grey bars representing seller transactions. Accordingly, reference numeral 42 indicates a buyer bar which is created, according to the current arrangement, at the completion of the buyer bar indicated by reference numeral 40, but it is not permanently located on the chart until the nominated volume of buying has been completed. This feature allows the current arrangement to show exactly how much completed selling has occurred at the bar indicated by reference numeral 43 C. In the current example, the ratio of sellers to buyers is 3 to 1. Similarly, a ratio of 5 to 1 between seller and buyers is shown at reference numeral 45.

Reference numeral 44 indicates the amount of time in seconds each side, i.e. buyers and sellers, is transacting in, and reference numeral 46 indicates a situation where a bar is faster than the same transactions bar, i.e. a black blip means that the last buying bar is faster than the second to last buying bar.

Reference numeral 48 indicates a time of day and is only located on the chart when the bar above has completed its relevant volume. The varying widths of time are shown indicating the varying speed of the market transacting. As mentioned above, the method of the current arrangement displays a volume of transactions and not according to set time periods. Reference numeral 50 shows a faster same transaction bar, typically indicated in a bold colour on the chart, to alert a trader to an increased speed of the transactions taking place.

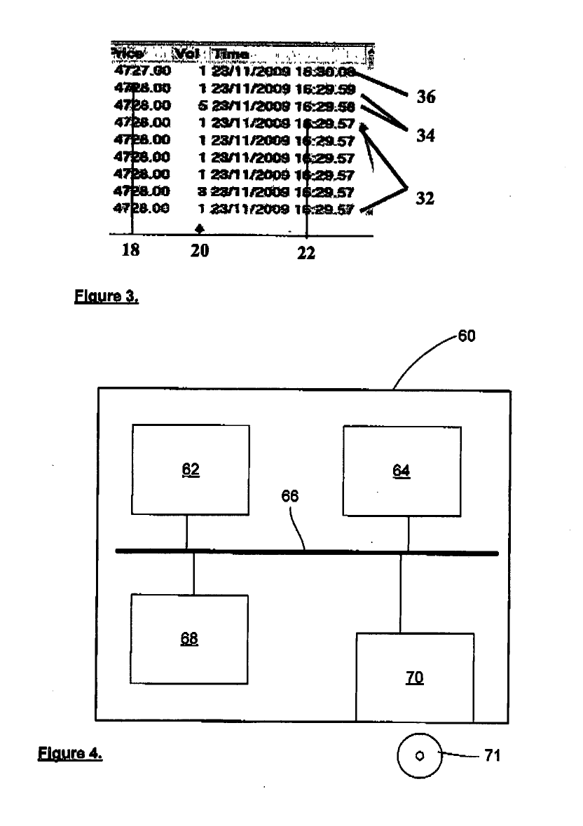

FIG. 4 shows an example of a system 60 for representing stock market transactions, for example to generate the screen shown in FIG. 3. The system 60 typically includes a processor 62 for executing instructions and memory 68 arranged in signal communication with the processor 62 via a communications bus 66. The memory 68 typically stores the instructions. The system 60 also includes non-volatile storage 64 arranged in signal communication with the memory 68 and processor 62 via the bus 66, with the storage 64 configured for storing the instructions in a non-volatile manner. As is well understood in the art, memory 68 is generally a high-speed volatile memory, with storage 64 being non-volatile lower-speed storage. Prior to the processor 62 executing the instructions, the instructions are transferred from storage 64 to the memory 68 via the bus 66, as is well understood in the art.

The system 60 also includes an interface 70 arranged in signal communication with the processor 63, memory 68 and storage 64 via bus 66, as shown. The interface 70 is for receiving instructions from a user and for displaying results of the executed instructions to the user. The interface may include any suitable device, such as a keyboard, a mouse, a screen, a printer, etc. The processor 62 is configured to execute the set of instructions in order to perform the method steps as described above. The results of the instructions are typically displayed on a suitable screen as part of the interface 70. In addition, the current arrangement includes a computer-readable medium 71 which includes a set of instructions which, when executed by the processor 62, causes the system or computer 60 to perform the above method steps.

The set of instructions executed by the processor 62 enables the system 60 to determine which party (buyer/seller) initiated a transaction that is recorded, in the price column indicated by reference numeral 18 in FIG. 1 by establishing the exact time the order was created, the older order in the 2 party matched process is the offering party, then confirms which column the order came from, being either the Bid column 12 or the Ask column 14, in order to establish if it was a buying or selling transaction which occurred. The system 60 then creates two data streams, namely the buyer data stream and the seller data stream, according to this comparison. As such, a data stream which measures all the transacting that buyers do and a data stream measuring all the transacting that sellers do are created. These data streams are then plotted in real-time the single chart of FIG. 2 providing an exact representation of which party was involved in which transaction using the volume of transactions itself as an increment of measurement.

Similarly, the method enables the measurement of a current achievement of buyers versus sellers, including in indication of a raw speed of transacting. In addition, it is possible to create accurate angles of achievement by eliminating time as an increment of measurement. As it is also possible to measure accurately the horizontal space on the chart, it is also possible to effectively measure the impact an offer is having on current price.

FIG. 5 shows an example of an additional indicator for showing a speed at which transactions occur. This indicator is typically positioned at the bottom of the chart of FIG. 2 and forms an indicator of the market speed and can alert the trader as to what size chart should be used as calculated by dividing the volume of transactions by the number of seconds and multiplying the result by sixty. The indicator is intended to ensure that the trader does not use too small a chart size for the relevant transaction speed of the market.

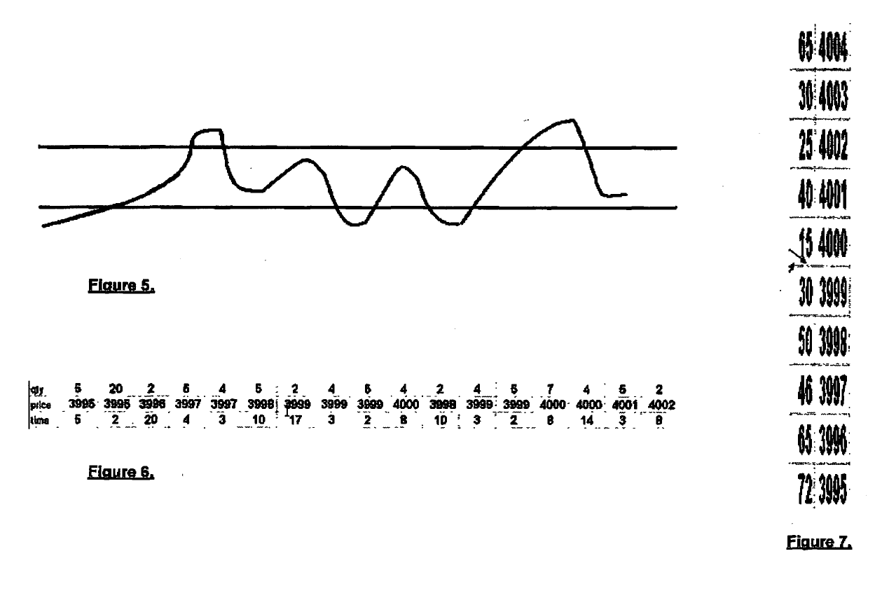

Referring now to FIG. 6, therein is shown another indicator which is generally incorporated at the bottom of the chart of FIG. 2. The indicator shows the course of sales and also shows the actual transaction by either the buyer or seller who created the transaction, as well as the total volume for the created transaction. It also shows the amount of time since the last same transaction occurred. This indicator can tell the trader what is currently going on in the market and who is doing what in what volume and at what speed, which indicates commitment.

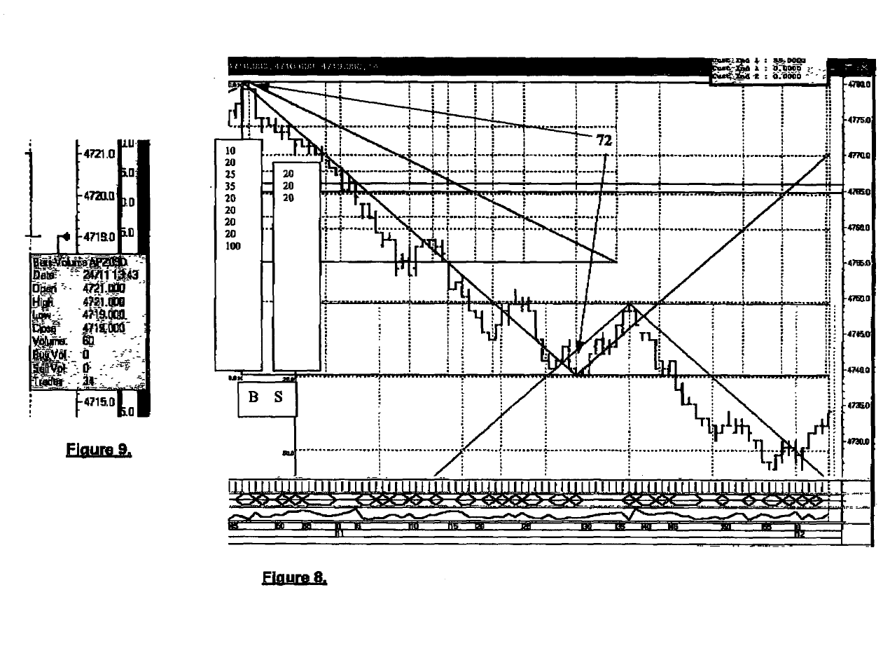

FIG. 7 shows a yet further indicator forming part of the chart of FIG. 2. The indicator shows the bid and offer, and is typically displayed on the right hand side of the chart, to provide the trader with more information at a glance.

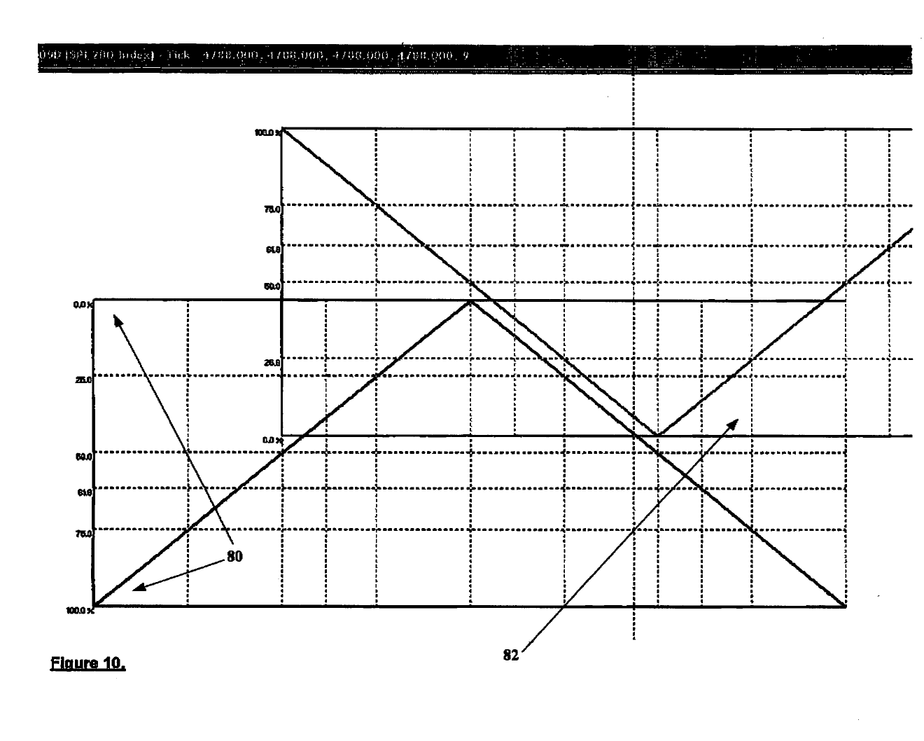

FIG. 8 shows a squared marked achievement indicator of the chart of FIG. 2. FIG. 9 shows a data box which will also have a field at the bottom which will represent the range of the bar and it will show the amount of volume transacted at each price point in the range. Referring back to FIG. 8, this information will then typically be displayed down the left hand side of the chart as squared market achievement and presenting an accurate prediction of space into the future, to allow for comparison and square achievement. This feature is recording all the volume transacted by both parties across the range indicated at reference numeral 72. The trader is able to tell exactly what volume has been sold and bought at price points, once he has established a range to trade.

A further example of the current arrangement can also include an Equivolume chart based on buy sell data using set increments of time, e.g. 5 minute interval bars, or the like. The current arrangement can also feature a nominated period allowing the chart to represent market information according to market trading sessions, i.e. markets trade in sessions over the course of a full trading day session. For example, the Australian market has a morning session that covers 10.00 am until 12.30 pm, then a lunch session until 1.30 pm, then an afternoon session from 1.30 pm until 4.00 pm, and then an after market close session from 4.00 pm until 4.30 pm. Similarly, In Forex markets there are similar sessions and the nominated period allows a trader to keep track of these sessions accordingly. Forex markets typically trade at prices which have a spread for bid and ask. A similar method can be used to determine if a transaction was bought or sold, however, a tick chart is used instead of a volume chart.

In conventional methods, an Equivolume chart is calculated by adding the volume of the total bars displayed on the chart together, than each bars' volume is divided into the total volume on display and its percentage value of the total is proportioned to the width of the bar. However, one problem associated with this conventional method is that it is processor intensive to calculate, and each time the display size is changed by a new bar being created, or by looking at a different size data sample, each bar's space allocation changes so that the total volume or history of the transactions is changed which affect the calculation.

An Equivolume chart according to the current arrangement will have fixed width history and only the last bar will be live and changing in width until it is completed. This is achieved by having an input that allows the trader to input a value that the current bar is calculated against, e.g. a 200 period average volume, or the like. This ensures that all bars are proportionate to each other and also creates a permanent history of transactions.

The Equivolume chart relies on time based increments of measurement which means that speed cannot be measured. However, this chart will use actual volume which is similar to speed. So instead of speed increasing, the volume will be decreasing, typically indicated on the chart by a bold printed bar which will occur as a bar having less volume than the preceding same transaction bar. The indicator of FIG. 5 provides an indication of the relative market speed.

FIG. 10 shows an analysis of the chart of FIG. 2 and is used to aid in the interpretation of market activity. Reference numeral 80 generally indicates where information collected from the data box of FIG. 9 is displayed. The grid indicated at reference numeral 82 shows a predicted path of achievement according to the accumulated data and is a reaction or retracement of activity. Further examples may indicate this information in another manner, e.g. using a manner reducing an amount of noise on the chart, or the like.

The current arrangement provides for a chart which is designed to visually represent market course of sales activity to assist traders in their decision making process. In addition, additional indicators are able to extract information from the course of sales and are incorporated into the chart to assist the trader in the decision making process.

It is to be appreciated that reference to the term “financial market” includes reference to any market allowing the buying and selling, i.e. trade, of any financial securities (such as stocks and bonds), commodities (such as precious metals or agricultural goods), and other fungible items, or the like. Accordingly, reference to a term such as “stock” should be taken to include reference to any suitable securities, commodities and similar fungible items according to circumstances.

Many modifications or variations will be apparent to those skilled in the art without departing from the scope of the present invention. All such variations and modifications should be considered to fall within the spirit and scope of the invention broadly appearing and described in more detail herein.

It is to be appreciated that reference to “one example” or “an example” of the invention is not made in an exclusive sense. Accordingly, one example may exemplify certain aspects of the invention, whilst other aspects are exemplified in a different example. These examples are intended to assist the skilled person in performing the invention and are not intended to limit the overall scope of the invention in any way unless the context clearly indicates otherwise.

Features that are common to the art are not explained in any detail as they are deemed to be easily understood by the skilled person. Similarly, throughout this specification, the term “comprising” and its grammatical equivalents shall be taken to have an inclusive meaning, unless the context of use clearly indicates otherwise.

1. A method of representing financial market transactions, said method including the steps of:
recording a time an order was created in a course of sales;
determining whether the order was for buying or selling of a fungible item;
generating a buyer data stream representative of buying transactions according to the buying of such fungible items;
generating a seller data stream representative of selling transactions according to the selling of fungible items; and
representing the buyer data stream and the seller data stream on a chart, wherein the financial market transactions are simultaneously represented according to a volume of both
buyer and seller transactions.

2. The method of claim 1, wherein the step of determining whether the order was for buying or selling of fungible items includes determining whether the order was recorded as a buyer bid or as a seller bid at the time of the order.

3. The method of claim 1, including determining a current achievement level of buyer transactions and seller transactions via comparison of the volume of buyer and seller transactions.

4. The method of claim 1, which is performed in real-time as the transactions are concluded.

5. A system for representing financial market transactions, said system including:
a processor for executing instructions;
memory arranged in signal communication with the processor via a communications bus, said memory for storing the instructions;
non-volatile storage arranged in signal communication with the memory and processor via the bus, the storage configured for storing the instructions; and
an interface arranged in signal communication with the processor, memory and storage, the interface for receiving instructions from a user and for displaying results of the executed instructions to the user, wherein the processor is configured to execute a set of instructions in order to perform a method according to claim 1.

6. A computer-readable medium which includes a set of instructions which, when executed by a processor, causes a computer to perform the method steps of claim 1.

7. A general-purpose digital computer programmed to carry out steps according to the method of claim 1.

8.-9. (canceled)
